(19) United States
(12) Patent Application Publication
(10) Pub. No.: US 2003/0085056 A1
(43) Pub. Date: May 8, 2003

(54) Pick and place holes and clips for cable management

(76) Inventors: Brett Goldstein, Kensington, MD (US); Brent Ashley Miller, Baltimore, MD (US)

Correspondence Address: HARRITY & SNYDER, LLP, 11240 WAPLES MILL ROAD, SUITE 300, FAIRFAX, VA, 22030, US

(21) Appl. No.: 09/985,267

(22) Filed: Nov. 2, 2001

(51) Int. Cl. H01B 17/00; H02G 3/00

(52) U.S. Cl. 174/260; 174/138 G

(57) ABSTRACT

A pick and place hole or clip is automatically surface mounted on a board, such as a printed circuit board. The hole or clip includes a securing portion and a mounting portion. The securing portion is configured to secure a cable, a component, or a clip. The mounting portion is configured to be surface mounted on the board by solder.

### BACKGROUND OF THE INVENTION

1. Field of the Invention

The present invention relates generally to surface mount mechanisms and, more particularly, to systems and methods for managing cables, and possibly other components, using pick and place holes and/or clips.

2. Description of Related Art

Cables, such as electrical conductors and optical fibers, are used in conjunction with printed circuit boards (PCBs) to carry signals between components and devices connected to the PCBs. Three conventional techniques have been used to secure these cables to the PCB.

A first technique uses a cable clip that is secured to a PCB via a through-hole. FIGS. 1A and 1B illustrate this first conventional technique. As illustrated in FIGS. 1A and 1B, a cable clip 110 is inserted in a PCB 120 via a through-hole 130. The clip 110 includes a cable securing portion 112 and a clip securing portion 114 (FIG. 1A). The cable securing portion 112 secures a cable. The clip securing portion 114 may include a press bit, screw, or other mechanism that secures the clip 110 against the PCB 120 via the through-hole 130. The clip 110 is inserted in the through-hole 130 of the PCB 120 (FIG. 1B), such that the clip securing portion 114 holds the clip 110 securely against the PCB 120. A cable may then be inserted into and secured by the cable securing portion 112.

There are several disadvantages to this technique. For example, putting holes in the PCB 120 presents problems, such as weakening the board, cutting up the power and ground planes of the board, and diminishing the area of the board available to transfer signals. Also, clips 110 often cannot be automatically placed on the PCB 120 by pick and place machines. Pick and place machines require a relatively large, flat area on the outer surface of a component for engagement by a vacuum pick and place tool. Clips are typically too small in diameter to be reliably picked up by the vacuum tool. As a result, placement of the clips requires manual labor. Manual labor is more expensive, takes longer, and is less reliable than automated methods.

A second technique uses a cable clip that includes an adhesive. FIGS. 2A and 2B illustrate this second conventional technique. As illustrated in FIGS. 2A and 2B, a cable clip 210 attaches to a PCB 220 via an adhesive 214. The clip 210 includes a cable securing portion 212 and an adhesive 214 (FIG. 2A). The cable securing portion 212 secures a cable. The adhesive 214 may include tape or glue that secures the clip 210 to the PCB 220. A cable may then be inserted into and secured by the cable securing portion 212.

This technique also has disadvantages. For example, the adhesive is typically not very reliable under all humidity and/or temperature conditions. Also, clips 210 often cannot be automatically placed on the PCB 220 by pick and place machines. Manual labor is usually required to secure the clips 210 to the PCB 220. As described above, manual labor is more expensive, takes longer, and is less reliable than automated methods.

A third technique uses a metal cable clip that is secured to a printed circuit board using solder. FIGS. 3A and 3B illustrate this third conventional technique. As illustrated in FIGS. 3A and 3B, a cable clip 310 attaches to a PCB 320 using solder. The clip 310 includes a cable securing portion 312 and a soldering portion 314 (FIG. 3A). The cable securing portion 312 secures a cable to the PCB 320. The soldering portion 314 provides a surface that is soldered to the PCB 320.

This technique also has disadvantages. For example, sometimes the cable clip 310 is installed after the cable is put in place on the PCB 320 or the cable is attached to the cable clip 310 before attaching the cable clip 310 to the PCB 320. In either case, this makes attachment of the cable clip 310 difficult by automated methods. Alternatively, the cable clip 310 is first secured to the PCB 320 and the cable is then fed through the cable clip 310. This is an unwise method of handling cables, such as fibers, due to bend radius concerns and the potential for damage to the cables by the metal clip 310.

Accordingly, there is a need in the art for mechanisms to secure cables or other components to a PCB.

### SUMMARY OF THE INVENTION

Systems and methods consistent with the present invention address this and other needs by providing pick and place holes and clips that are automatically placed and soldered to a printed circuit board for securing cables, and possibly other components, to the printed circuit board.

In accordance with the principles of this invention as embodied and broadly described herein, a pick and place hole that is automatically surface mounted on a board includes a securing portion and a mounting portion. The securing portion is configured to secure a cable, a component, or a clip. The securing portion includes an opening configured to receive and preclude rotation of the cable, component, or clip. The mounting portion is configured to be surface mounted on the board by solder.

In another implementation consistent with the present invention, a cable securing apparatus surface mounted on a board includes a clip and a pick and place hole. The clip is configured to secure one or more cables. The pick and place hole includes a securing portion and a mounting portion. The securing portion includes an opening configured to receive and preclude rotation of the clip. The mounting portion is configured to be surface mounted on the board by solder.

In yet another implementation consistent with the present invention, a method for securing one or more cables to a printed circuit board includes automatically placing a pick and place hole on the printed circuit board; automatically attaching the pick and place hole to the printed circuit board using solder; attaching a clip to the pick and place hole; and inserting the one or more cables in the clip to secure the one or more cables to the printed circuit board.

In a further implementation consistent with the present invention, a method for routing one or more cables on a printed circuit board includes automatically placing a plurality of pick and place holes at a plurality of locations on the printed circuit board; automatically attaching the pick and place holes to the printed circuit board using solder; attaching a clip to each of the pick and place holes; and inserting the one or more cables in the clips to route the one or more cables on the printed circuit board.

In another implementation consistent with the present invention, a cable securing apparatus that is surface mounted on a board includes a plastic clip that is configured to secure one or more cables to the board and at least one solderable portion, attached to the plastic clip, that is configured to be surface mounted on the board by solder.

In a further implementation consistent with the present invention, a method for securing one or more cables to a printed circuit board includes automatically placing a pick and place clip on the printed circuit board, the pick and place clip including a plastic cable securing portion and a solderable mounting portion; automatically attaching the pick and place clip to the printed circuit board using solder; and inserting the one or more cables in the pick and place clip to secure the one or more cables to the printed circuit board.

In yet another implementation consistent with the present invention, a method for routing one or more cables on a printed circuit board includes automatically placing a plurality of pick and place clips at a plurality of locations on the printed circuit board, each of the pick and place clips including a plastic cable securing portion and a metal mounting portion; automatically soldering the mounting portions of the pick and place clips to the printed circuit board; and inserting the one or more cables in the clips to route the one or more cables on the printed circuit board.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIGS. 1A and 1B illustrate a first conventional technique for securing cables;

FIGS. 2A and 2B illustrate a second conventional technique for securing cables;

FIGS. 3A and 3B illustrate a third conventional technique for securing cables;

FIG. 4 illustrates an exemplary system in which systems and methods consistent with the present invention may be implemented;

FIGS. 5A-5C are exemplary diagrams of a pick and place hole according to an implementation consistent with the present invention;

FIGS. 6A-6C are exemplary diagrams of a pick and place hole according to another implementation consistent with the present invention;

FIGS. 7A-7C are exemplary diagrams of a pick and place hole according to yet another implementation consistent with the present invention;

FIGS. 8A and 8B are side and front views of a pick and place hole attached to a printed circuit board (PCB);

FIGS. 9A-9F are various views of a pick and place hole attached to a PCB according to an alternate implementation consistent with the present invention;

FIGS. 10A and 10B are exemplary diagrams of a pick and place clip according to an implementation consistent with the present invention;

FIGS. 11A-15 illustrate various pick and place clips in accordance with alternate implementations consistent with the present invention;

FIGS. 16A-16F are various views of a pick and place clip attached to a PCB according to an alternate implementation consistent with the present invention;

FIG. 17 is a flowchart of exemplary processing for placing a pick and place hole/clip according to an implementation consistent with the present invention; and

FIG. 18 is an exemplary diagram of the use of pick and place holes/clips to route one or more cables according to an implementation consistent with the present invention.

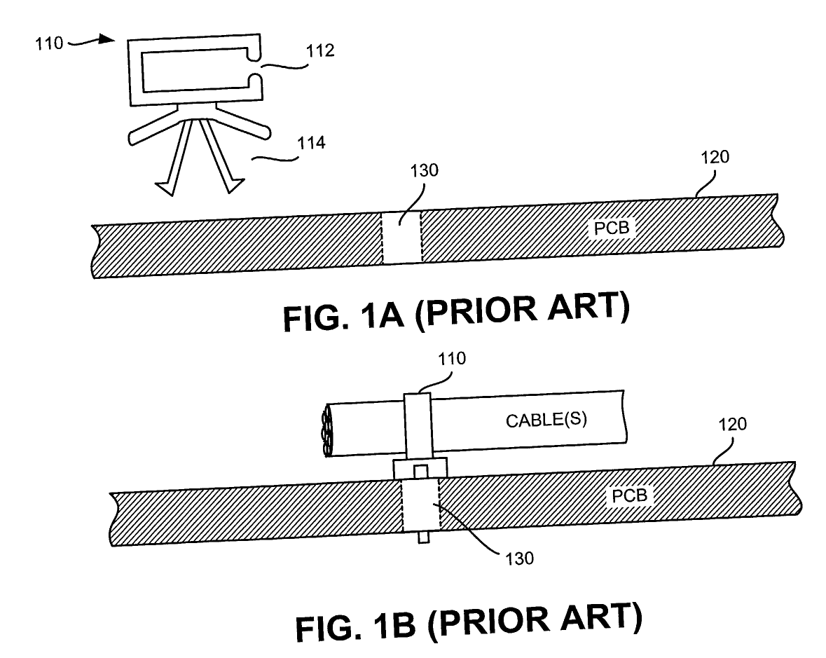

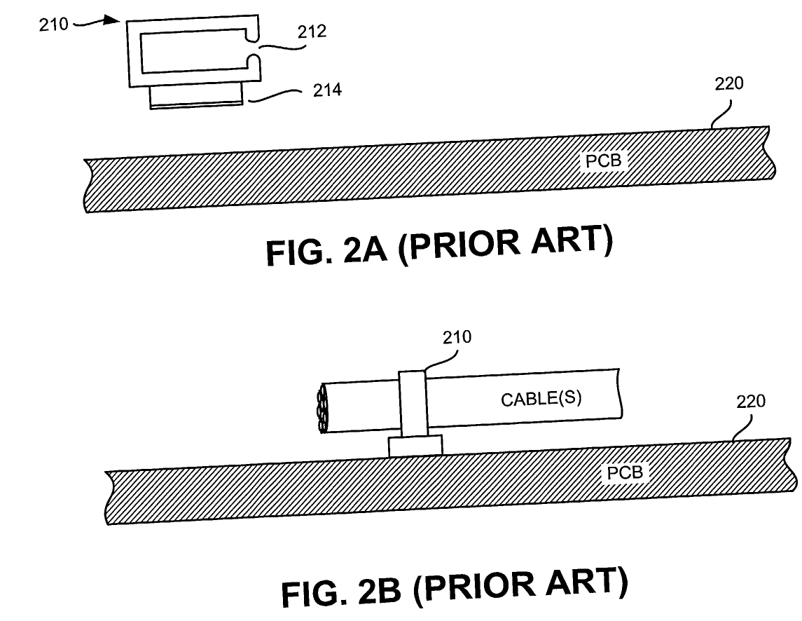

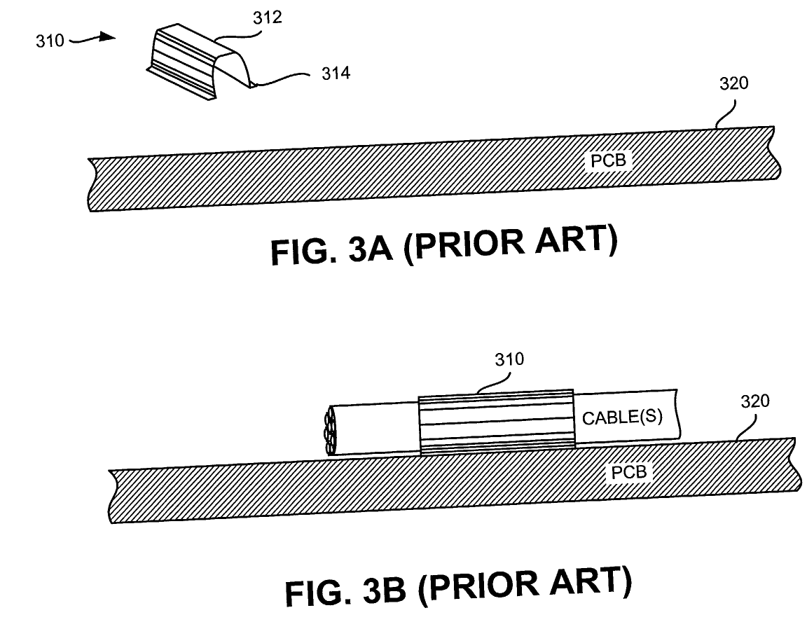

### DETAILED DESCRIPTION

The following detailed description of implementations consistent with the present invention refers to the accompanying drawings. The same reference numbers in different drawings may identify the same or similar elements. Also, the following detailed description does not limit the invention. Instead, the scope of the invention is defined by the appended claims and equivalents.

Systems and methods consistent with the present invention provide pick and place holes and clips that are surface mounted with solder to secure cables, and possibly other components, to a printed circuit board (PCB). A clip may be used in combination with a pick and place hole to secure a cable. Multiple clips may be used to route one or more cables on the PCB. The pick and place holes may be designed with an opening that precludes rotation of items inserted therein, such as a rectangular opening.

### Exemplary System Configuration

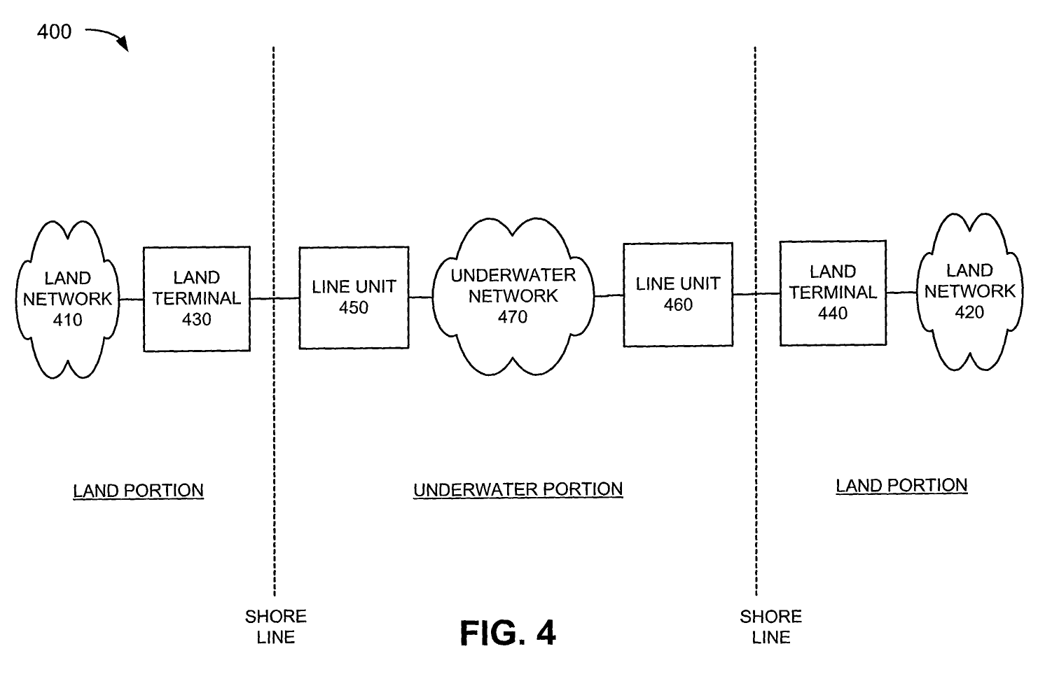

FIG. 4 illustrates an exemplary system 400 in which systems and methods consistent with the present invention may be implemented. As illustrated, system 400 includes two land communication portions that are interconnected via an underwater communication portion. The land portions may include land networks 410 and 420 and land terminals 430 and 440. The underwater portion may include line units 450 and 460 and an underwater network 470. Two land networks 410 and 420, land terminals 430 and 440, and line units 450 and 460 are illustrated for simplicity. It will be appreciated that a typical system may include more or fewer devices and networks than are illustrated in FIG. 4. Line units 450 and 460 are sometimes referred to as “repeaters.”

The land network 410 may include one or more networks, such as the Internet, an intranet, a wide area network (WAN), a local area network (LAN), or another type of network. The land network 420 may be the same type of network as land network 410 or a different type. The land terminal 430 may include a device that converts signals received from the land network 410 into optical signals for transmission to the line unit 450, and vice versa. Similarly, the land terminal 440 may include a device that converts optical signals received from the line unit 460 for transmission to the land network 420, and vice versa. The land terminals 430 and 440 may connect to the land networks 410 and 420 via wired, wireless, or optical connections. In an implementation consistent with the present invention, the land terminals 430 and 440 connect to the line units 450 and 460 via optical connections.

The land terminals 430 and 440 may include, for example, long reach transmitters/receivers that convert signals into an optical format for long haul transmission and convert underwater optical signals back into a format for transmission to the land networks 410 and 420. The land terminals 430 and 440 may also include wave division multiplexers and optical conditioning units that multiplex and amplify optical signals prior to transmitting these signals to line units 450 and 460, and line current equipment that provides power to the line units 450 and 460 and underwater network 470.

The underwater network 470 may include groups of line units and/or other devices capable of routing and amplifying optical signals in an underwater environment. The line units 450 and 460 may include devices capable of receiving, processing, and transmitting optical signals to land terminals 430 and 440 or other line units via the underwater network 470. PICK AND PLACE HOLES

The land terminals 430 and 440 and/or the line units 450 and 460 may include certain PCBs that contain components for receiving, processing, and transmitting signals. The land terminals 430 and 440 and/or the line units 450 and 460 may also include cables, such as optical fibers or other wiring, for routing signals between components or devices.

According to implementations consistent with the present invention, pick and place holes are used to secure cables, or possibly other components, to a PCB. The pick and place holes may be automatically soldered to the PCB by a pick and place machine. The pick and place holes may be used alone or in combination with a clip to secure the cables.

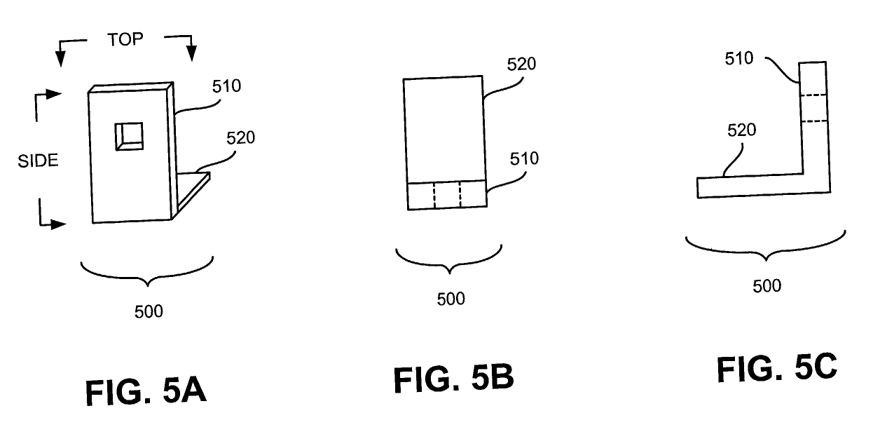

FIGS. 5A-5C are exemplary diagrams of a pick and place hole 500 according to an implementation consistent with the present invention. FIG. 5A illustrates a front view of the pick and place hole 500; FIG. 5B illustrates a top view of the pick and place hole 500; and FIG. 5C illustrates a side view of the pick and place hole 500.

The pick and place hole 500 includes securing portion 510 and mounting portion 520. The securing and mounting portions 510 and 520 may be constructed of a single piece of material, such as metal, or different types of material, such as a combination of plastic and metal. For example, the securing portion 510 may be constructed of a rigid or semi-rigid material, such as a metal or plastic material. The securing portion 510 includes an opening that permits a cable, component, or clip to be held by the pick and place hole 500 without rotation. In this particular implementation, the opening is a rectangular-shaped opening. The mounting portion 520 may be constructed of a solderable material, such as tin-plated brass, that permits the pick and place hole 500 to be soldered to a PCB.

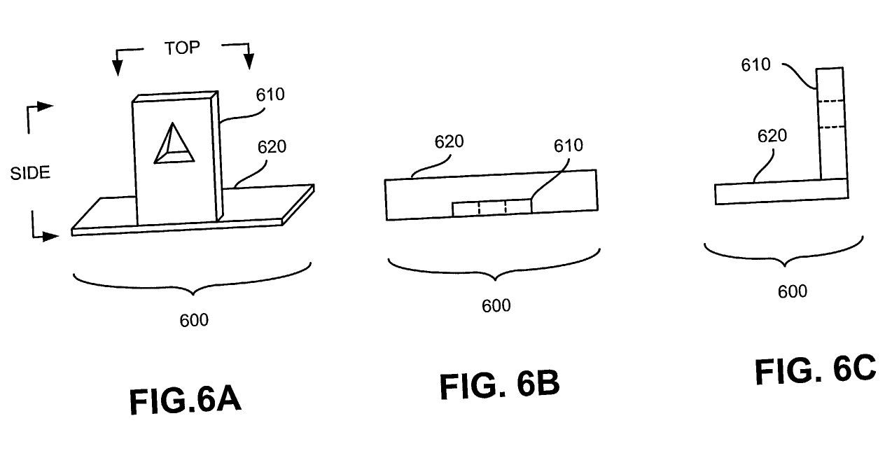

FIGS. 6A-6C are exemplary diagrams of a pick and place hole 600 according to another implementation consistent with the present invention. FIG. 6A illustrates a front view of the pick and place hole 600; FIG. 6B illustrates a top view of the pick and place hole 600; and FIG. 6C illustrates a side view of the pick and place hole 600.

The pick and place hole 600 includes securing portion 610 and mounting portion 620. The securing and mounting portions 610 and 620 may be constructed of a single piece of material, such as metal, or different types of material, such as a combination of plastic and metal. For example, the securing portion 610 may be constructed of a rigid or semi-rigid material, such as a metal or plastic material. The securing portion 610 includes an opening that permits a cable, component, or clip to be held by the pick and place hole 600 without rotation. In this particular implementation, the opening is a triangular-shaped opening. The mounting portion 620 may be constructed of a metallic material, such as tin-plated brass, that may be soldered to a PCB. In this implementation, the mounting portion 620 provides a larger area to secure the pick and place hole 600 to a PCB.

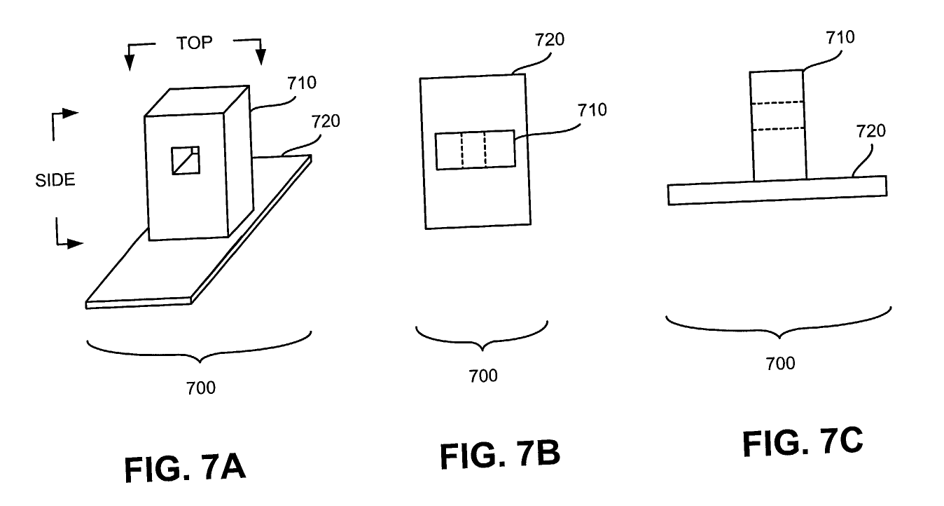

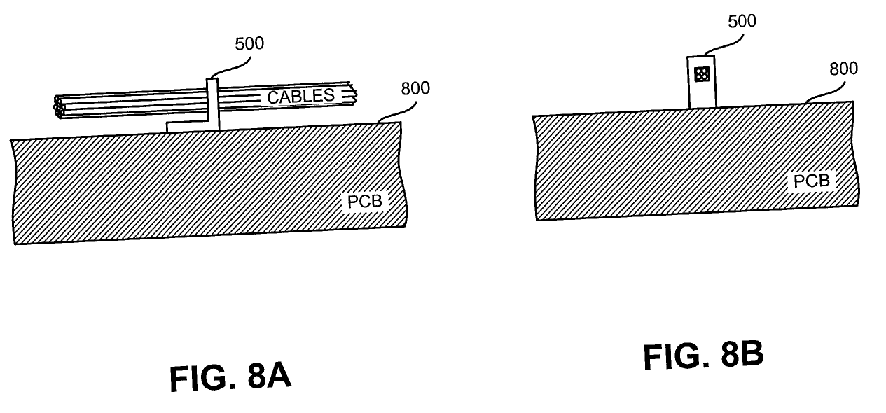

FIGS. 7A-7C are exemplary diagrams of a pick and place hole 700 according to yet another implementation consistent with the present invention. FIG. 7A illustrates a front view of the pick and place hole 700; FIG. 7B illustrates a top view of the pick and place hole 700; and FIG. 7C illustrates a side view of the pick and place hole 700.

The pick and place hole 700 includes securing portion 710 and mounting portion 720. The securing and mounting portions 710 and 720 may be constructed of a single piece of material, such as metal, or different types of material, such as a combination of plastic and metal. For example, the securing portion 710 may be constructed of a rigid or semi-rigid material, such as a metal or plastic material. The securing portion 710 includes a rectangular opening that permits a cable, component, or clip to be held by the pick and place hole 700 without rotation. In this implementation, the securing portion 710 is thicker and more stable. The mounting portion 720 may be constructed of a metallic material, such as tin-plated brass, that may be soldered to a PCB.

The three configurations of pick and place holes that have been described with regard to FIGS. 5A-7C are provided only as examples. Other configurations are possible. For example, instead of a rectangular or triangular-shaped opening, a star-shaped or other shaped opening may be used so long as the opening is capable of reducing the likelihood of rotation of a cable, clip, or component inserted therein.

The pick and place holes may be attached to a PCB by solder. FIGS. 8A and 8B are side and front views of a pick and place hole 500 attached to a PCB 800. In this implementation, the pick and place hole 500 secures one or more cables via its rectangular opening. Making the opening rectangular precludes rotation of the cable(s).

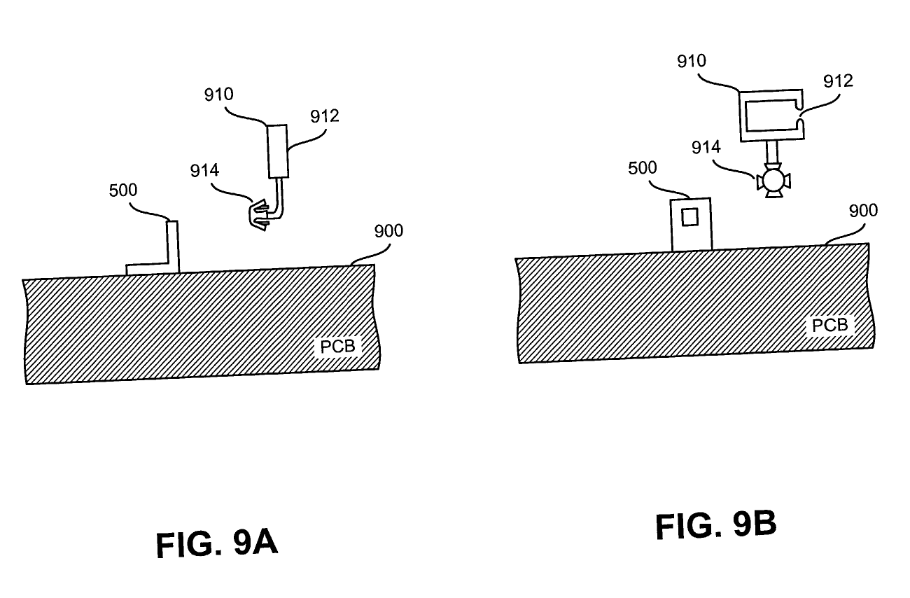

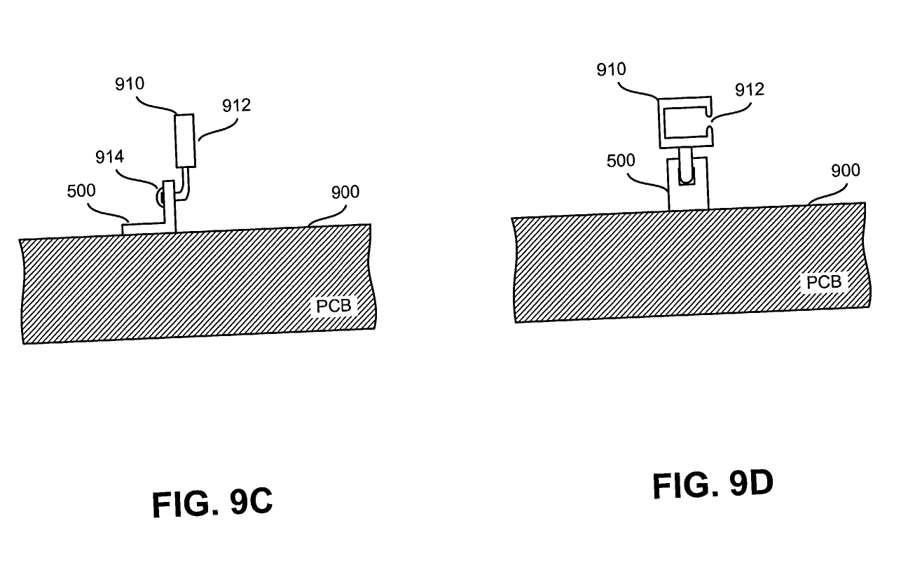

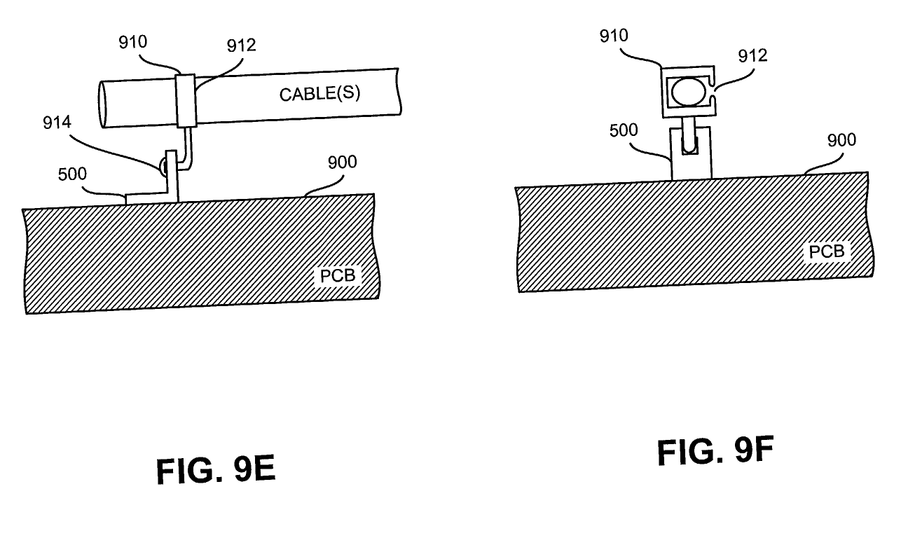

In an alternate implementation, the pick and place hole 500 secures one or more cables using a clip. FIGS. 9A-9F are various views of a pick and place hole 500 attached to a PCB 900 according to this alternate implementation. FIGS. 9A and 9B illustrate side and front views of the pick and place hole 500 and a clip 910 used to secure one or more cables. The clip 910 may be constructed of plastic or some other rigid or semi-rigid material. In one implementation, the clip 910 includes a conventional nylon or plastic clip manufactured by, for example, Richco, Inc.

The clip 910 may include a cable securing portion 912 and a hole engagement portion 914. The cable securing portion 912 and the hole engagement portion 914 may take many forms, such as the ones illustrated in FIGS. 9A and 9B. In other implementations, the cable securing portion 912 and the hole engagement portion 914 may be configured differently. The cable securing portion 912 may be configured to securely hold one or more cables. While illustrated as having a rectangular shape, the cable securing portion 912 may be of other shapes.

The hole engagement portion 914 may be configured to insert into the opening of the pick and place hole 500 and securely hold the clip 910 in its upright position. The shape of the opening (e.g., rectangular, triangular, etc.) of the pick and place hole 500 precludes the clip 910 from rotating once it has been inserted within the opening.

FIGS. 9C and 9D illustrate side and front views of the pick and place hole 500 with the clip 910 inserted. The hole engagement portion 914 is secured by the opening of the pick and place hole 500. FIGS. 9E and 9F illustrate side and front views of the pick and place hole 500 with one or more cables secured by the clip 910. The cable(s) may be inserted and secured by the cable securing portion 912.

### Pick and Place Clips

In the implementations described thus far, pick and place holes have been described as the mechanism used to secure cables and clips on a PCB. In other implementations consistent with the present invention, pick and place clips may be used to secure the cables.

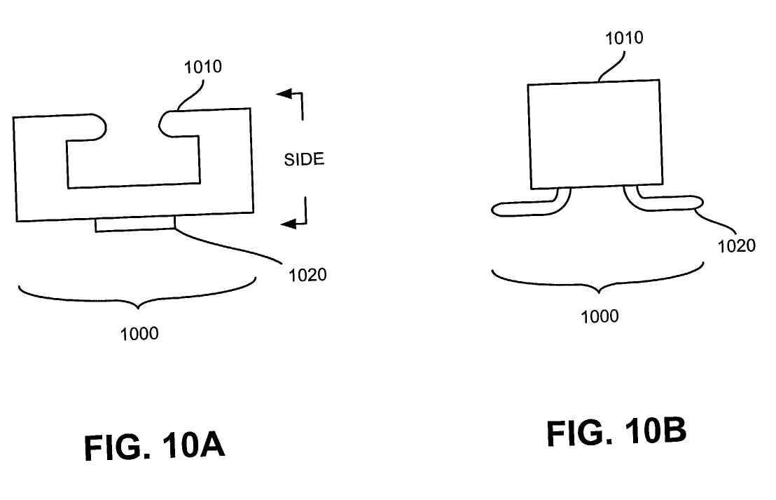

FIGS. 10A and 10B are exemplary diagrams of a pick and place clip 1000 according to an implementation consistent with the present invention. FIG. 10A illustrates a front view of the pick and place clip 1000; and FIG. 10B illustrates a side view of the pick and place clip 1000.

The pick and place clip 1000 includes a securing portion 1010 and a mounting portion 1020. The securing and mounting portions 1010 and 1020 may be constructed of a single piece of material, such as metal, or different types of material, such as a combination of plastic and metal. For example, the securing portion 1010 may be constructed of a rigid or semi-rigid material, such as injection molded plastic. The securing portion 1010 includes an opening that permits one or more cables, such as optical fiber(s), to be held by the pick and place clip 1000 without rotation. In other implementations, the opening takes the form of a cable guide. The mounting portion 1020 may include one or more tabs or pads that are constructed of a solderable material, such as tin-plated brass. The tabs or pads permit the pick and place clip 1000 to be soldered to a PCB.

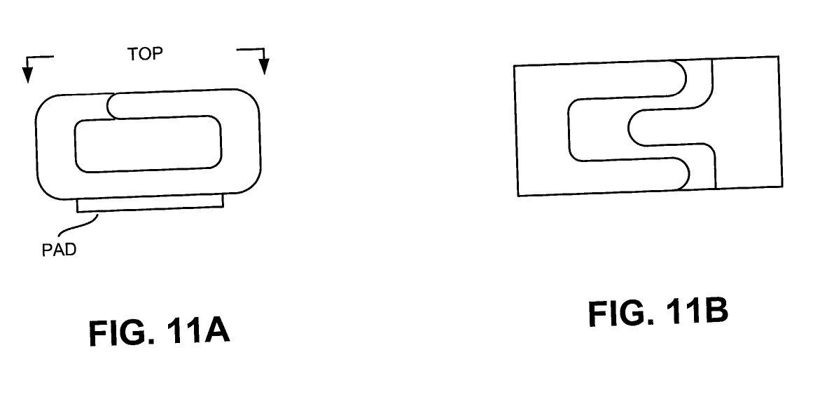

FIGS. 11A-15 illustrate various pick and place clips in accordance with alternate implementations consistent with the present invention. The pick and place clips may be constructed of injection molded plastic (or another type of rigid or semi-rigid material) with one or more solderable metal tabs or pads attached to permit the clips to be soldered to a PCB. Alternatively, the pick and place clips may be constructed entirely of a solderable material.

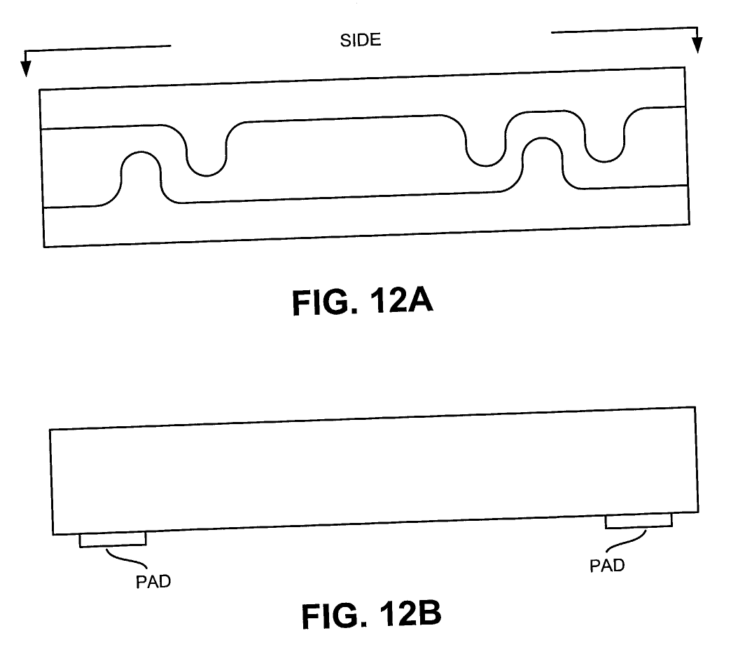

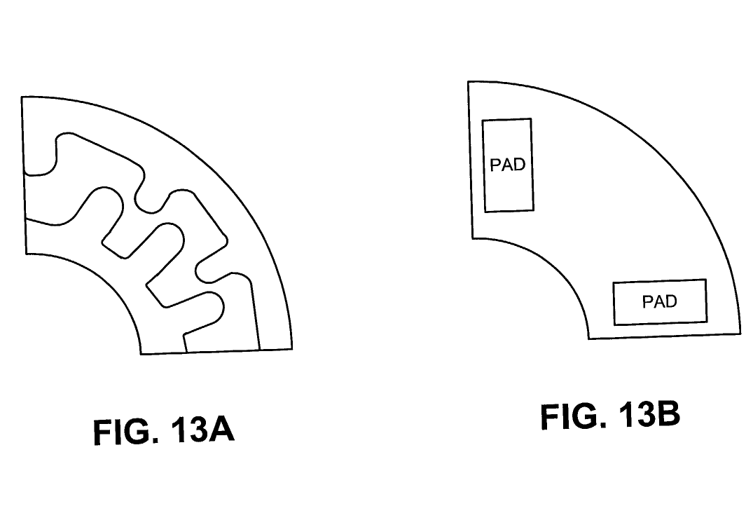

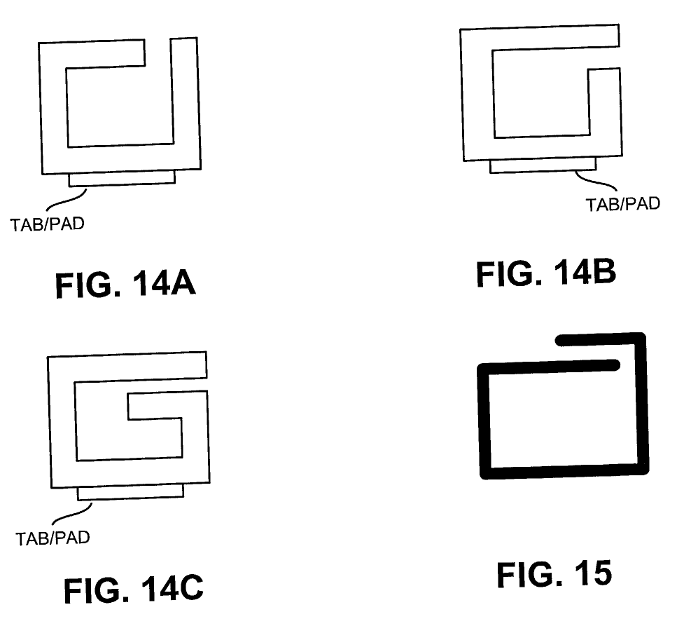

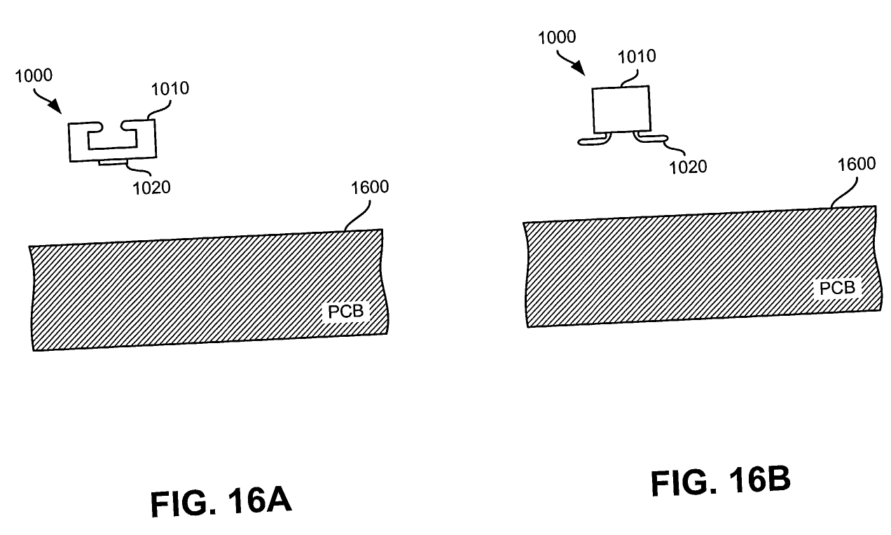

FIGS. 11A and 11B illustrate front and top views of a plastic clip in the form of a cable guide with a solderable metal pad. FIGS. 12A and 12B illustrate top and side views of a plastic clip that takes the form of a straight cable guide with solderable metal pads or tabs. FIGS. 13A and 13B illustrate top and bottom views of a plastic clip that takes the form of a curved cable guide with solderable metal pads. FIGS. 14A-14C illustrate various forms of plastic clips with one or more solderable metal pads or tabs. FIG. 15 illustrates a clip formed entirely of solderable metal. In this implementation, the clip itself may be soldered to the PCB.

The specific pick and place clips that have been described with regard to FIGS. 10A-15 are provided only as examples. The clips may take other forms in other implementations consistent with the present invention. Moreover, the number of pads or tabs used to secure the clips to the PCB may also vary in other implementations.

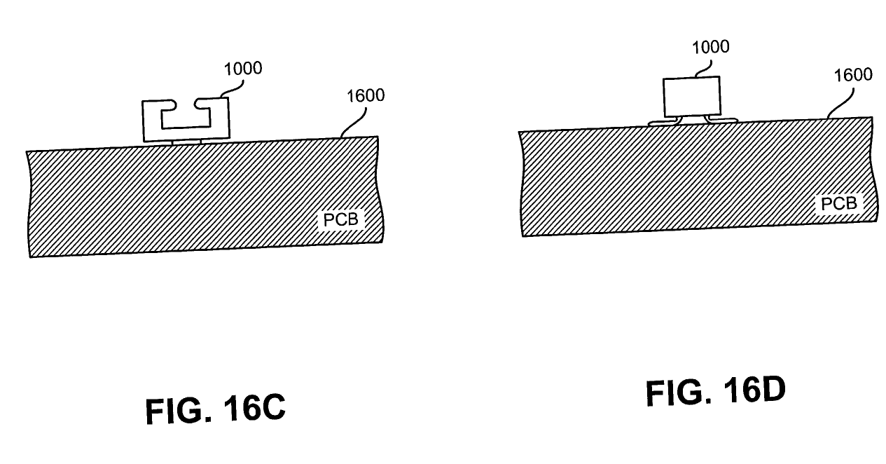

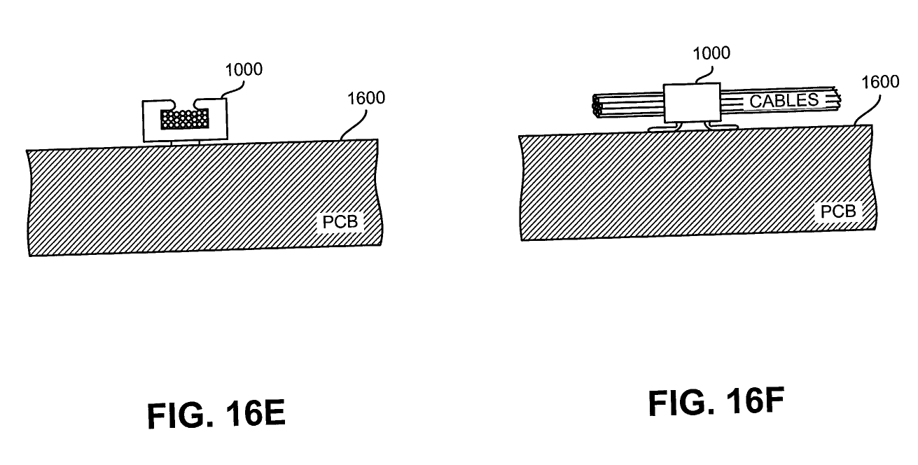

FIGS. 16A-16F are various views of a pick and place clip 1000 attached to a PCB 1600 according to an implementation consistent with the present invention. FIGS. 16A and 16B illustrate front and side views of the pick and place clip 1000 used to secure one or more cables.

The pick and place clip 1000 may include a securing portion 1010 and a mounting portion 1020. The securing portion 1010 and the mounting portion 1020 may take many forms, such as the ones illustrated in FIGS. 16A and 16B. In other implementations, the securing portion 1010 and the mounting portion 1020 may be configured differently. The securing portion 1010 may be configured to securely hold one or more cables. While illustrated as having a rectangular shape, the securing portion 1010 may be of other shapes.

The mounting portion 1020 may be configured to attach to the PCB 1600. The mounting portion 1020, as illustrated in FIGS. 16A and 16B, includes two mounting clips that permit the pick and place clip 1000 to be soldered to the PCB 1600. In other implementations, the mounting portion 1020 may take other forms, such as one or more solderable pads.

FIGS. 16C and 16D illustrate front and side views of the pick and place clip 1000 attached to the PCB 1600. The pick and place clip 1000 may be attached to the PCB 1600 via the mounting portion 1020. FIGS. 16E and 16F illustrate front and side views of the pick and place clip 1000 with one or more secured cables. The cable(s) may be inserted and secured by the securing portion 1020.

### Processing for Placing Pick and Place Holes/Clips

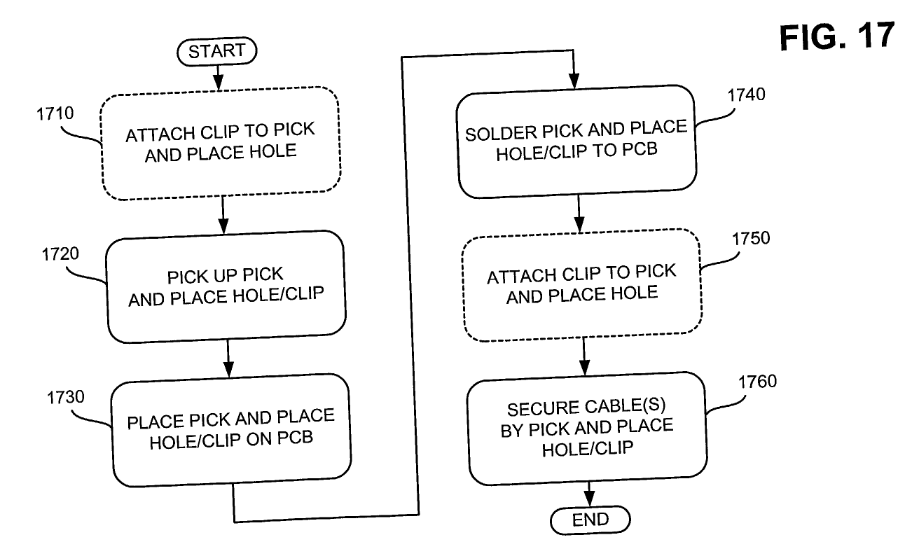

FIG. 17 is a flowchart of exemplary processing for placing a pick and place hole/clip according to an implementation consistent with the present invention. In the case of a pick and place hole, processing may begin with the optional act of attaching a clip to the pick and place hole [act 1710]. The clip may be manually, or automatically, inserted in the opening of the pick and place hole.

A pick and place machine may use a vacuum tool to pick up the pick and place hole/clip [act 1720]. The pick and place machine may then place the hole/clip at an appropriate location on a PCB [act 1730]. The pick and place machine may be programmed to place the hole/clip at a predetermined location on the PCB. The pick and place machine, or another machine, may then attach the hole/clip to the PCB using solder [act 1740].

As an optional next act in the case of a pick and place hole, a clip may be attached to the pick and place hole if this act has not already been completed [act 1750]. The clip may be manually, or automatically, inserted in the opening of the pick and place hole.

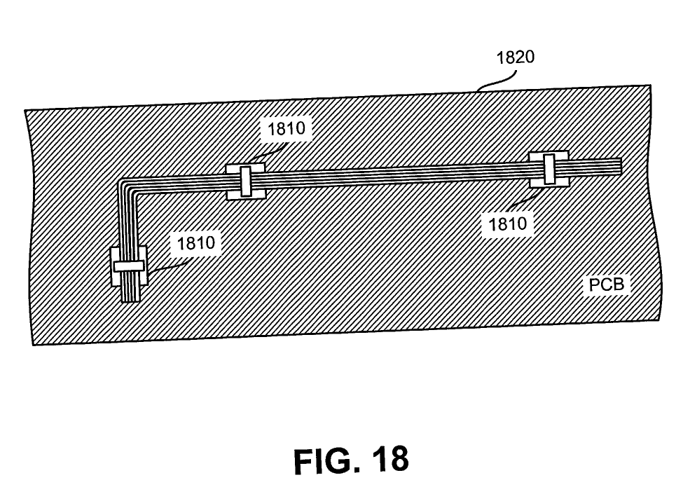

One or more cables or other components may then be inserted into and secured by the pick and place hole/clip [act 1760]. Multiple pick and place holes/clips may be used to route one or more cables on a PCB. FIG. 18 is an exemplary diagram of the use of pick and place holes/clips to route one or more cables according to an implementation consistent with the present invention. As shown, pick and place holes/clips 1810 may be positioned to route the cable(s) around the PCB 1820.

### CONCLUSION

Systems and methods, consistent with the present invention, provide pick and place holes and clips that are surface mounted with solder to secure cables, and possibly other components, to a PCB. A clip may be used in combination with a pick and place hole to secure a cable. The pick and place holes may be designed with an opening that precludes rotation of the cables and/or clips inserted therein. Multiple holes/clips may be used to route one or more cables on the PCB.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while the pick and place holes/clips have been described as securing one or more cables, the holes/clips may alternatively be used to secure other components, such as electronic components.

Moreover, while the description with regard to FIGS. 9A-16F focused on a clip with a single cable securing portion, clips with multiple cable securing portions may be used in other implementations consistent with the present invention. The presence of multiple cable securing portions would permit multiple cables or groups of cables to be secured in parallel.

No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the claims and their equivalents.

What is claimed is:

1. A pick and place hole configured to be automatically surface mounted on a board, comprising:
a securing portion configured to secure a cable, a component, or a clip, the securing portion including an opening configured to receive and preclude rotation of the cable, component, or clip; and
a mounting portion configured to be surface mounted on the board by solder.

2. The pick and place hole of claim 1, wherein the board is a printed circuit board.

3. The pick and place hole of claim 1, wherein the opening is one of a rectangular, triangular, and star-shaped opening.

4. The pick and place hole of claim 1, wherein the securing portion is comprised of plastic.

5. The pick and place hole of claim 1, wherein the securing portion and the mounting portion are comprised of metal.

6. The pick and place hole of claim 1, wherein the securing portion is configured to receive a clip for securing one or more cables.

7. The pick and place hole of claim 6, wherein the one or more cables include one or more optical fibers.

8. The pick and place hole of claim 6, wherein the clip includes:
a cable securing portion configured to secure one or more cables, and
a hole engagement portion configured to be inserted in the opening of the securing portion of the pick and place hole.

9. The pick and place hole of claim 1, wherein the pick and place hole is automatically placed on the board by a pick and place machine.

10. A cable securing apparatus surface mounted on a board, comprising:
a clip configured to secure one or more cables; and
a pick and place hole comprising:
a securing portion including an opening configured to receive and preclude rotation of the clip, and
a mounting portion configured to be surface mounted on the board by solder.

11. The apparatus of claim 10, wherein the board is a printed circuit board.

12. The apparatus of claim 10, wherein the opening is one of a rectangular, triangular, and star-shaped opening.

13. The apparatus of claim 10, wherein the clip is comprised of plastic.

14. The apparatus of claim 10, wherein the securing portion and the mounting portion are comprised of metal.

15. The apparatus of claim 10, wherein the one or more cables include one or more optical fibers.

16. The apparatus of claim 10, wherein the clip includes:
a cable securing portion configured to secure the one or more cables, and
a hole engagement portion configured to be inserted in the opening of the securing portion of the pick and place hole.

17. A method for securing one or more cables to a printed circuit board, comprising:
automatically placing a pick and place hole on the printed circuit board;
automatically attaching the pick and place hole to the printed circuit board using solder;
attaching a clip to the pick and place hole; and
inserting the one or more cables in the clip to secure the one or more cables to the printed circuit board.

18. The method of claim 17, wherein the attaching a clip to the pick and place hole occurs before automatically attaching the pick and place hole to the printed circuit board.

19. The method of claim 17, wherein the automatically placing a pick and place hole on the printed circuit board is performed by a pick and place machine.

20. The method of claim 17, wherein the pick and place hole includes:
a securing portion configured to secure the clip, the securing portion including an opening configured to receive and preclude rotation of the clip, and
a mounting portion configured to be surface mounted on the printed circuit board.

21. The method of claim 20, wherein the attaching a clip to the pick and place hole includes:
inserting a hole engagement portion of the clip into the opening of the securing portion of the pick and place hole.

22. A method for routing one or more cables on a printed circuit board, comprising:
automatically placing a plurality of pick and place holes at a plurality of locations on the printed circuit board;
automatically attaching the pick and place holes to the printed circuit board using solder;
attaching a clip to each of the pick and place holes; and
inserting the one or more cables in the clips to route the one or more cables on the printed circuit board.

23. A system for securing one or more cables to a printed circuit board, comprising:
means for automatically placing a pick and place hole on the printed circuit board;
means for automatically soldering the pick and place hole to the printed circuit board;
means for attaching a clip to the pick and place hole; and
means for inserting the one or more cables in the clip to secure the one or more cables to the printed circuit board.

24. A cable securing apparatus surface mounted on a board, comprising:
a plastic clip configured to secure one or more cables to the board; and
at least one solderable portion, attached to the plastic clip, configured to be surface mounted on the board by solder.

25. The apparatus of claim 24, wherein the board is a printed circuit board.

26. The apparatus of claim 24, wherein the at least one solderable portion is permanently attached to the plastic clip.

27. The apparatus of claim 24, wherein the one or more cables include one or more optical fibers.

28. The apparatus of claim 24, wherein the apparatus is automatically placed on the board by a pick and place machine.

29. A method for securing one or more cables to a printed circuit board, comprising:
automatically placing a pick and place clip on the printed circuit board, the pick and place clip including a plastic cable securing portion and a solderable mounting portion;
automatically attaching the pick and place clip to the printed circuit board using solder; and
inserting the one or more cables in the pick and place clip to secure the one or more cables to the printed circuit board.

30. The method of claim 29, wherein the automatically placing a pick and place clip on the printed circuit board is performed by a pick and place machine.

31. A method for routing one or more cables on a printed circuit board, comprising:
automatically placing a plurality of pick and place clips at a plurality of locations on the printed circuit board, each of the pick and place clips including a plastic cable securing portion and a metal mounting portion;
automatically soldering the mounting portions of the pick and place clips to the printed circuit board; and
inserting the one or more cables in the clips to route the one or more cables on the printed circuit board.
